(19) United States
(12) Patent Application Publication
(10) Pub. No.: US 2012/0150987 A1
(43) Pub. Date: Jun. 14, 2012

(54) TRANSMISSION SYSTEM AND APPARATUS, AND METHOD

(75) Inventor: Kazuaki NAGAMINE, Kawasaki (JP)

(73) Assignee: FUJITSU LIMITED

(21) Appl. No.: 13/405,067

(22) Filed: Feb. 24, 2012

Related U.S. Application Data
(63) Continuation of application No. PCT/JP2009/065494, filed on Sep. 4, 2009.

(51) Int. Cl. G06F 15/16; G06F 15/167

(52) U.S. Cl. 709/213; 709/217

(57) ABSTRACT

In a transmission system, a first transmitting apparatus (server node) acquires distribution data, which includes multiple update data sets and attribute information of the update data sets, from a file server via a second network. The first transmitting apparatus (server node) stores the attribute information so as to allow a second transmitting apparatus (client node) connected to the first transmitting apparatus (server node) via a first network to acquire the attribute information and determine necessity of acquisition with respect to each of the update data sets. The first transmitting apparatus (server node) also stores the update data sets to be acquired by the second transmitting apparatus (client node).

### CROSS-REFERENCE TO RELATED APPLICATION

This application is a continuing application, filed under 35 U.S.C. §111(a), of International Application PCT/JP2009/065494, filed on Sep. 4, 2009.

### FIELD

The embodiments discussed herein are related to a transmission system, a transmitting apparatus, and a transmitting method.

### BACKGROUND

In order to meet various needs of customers, it is sometimes the case that transmitting apparatuses (network devices) are composed of multiple units. In such a transmitting apparatus, updating of data including firmware and software is performed for functionality enhancement and failure handling purposes. Conventionally, as for updating of firmware for each unit mounted on a transmitting apparatus, the whole unit is sent to the factory of the vendor for rewriting the firmware and then shipped back to the customer. More recently, however, in terms of convenience, firmware rewriting is achieved via a network connected to a transmitting apparatus, instead of sending a corresponding unit of the transmitting apparatus to the factory. In addition, in the case where a unit that implements old version firmware is added as a component of the transmitting apparatus, the transmitting apparatus updates the old version firmware of the unit using update firmware stored in a nonvolatile memory. Accordingly, such a transmitting apparatus needs to be equipped with a high capacity nonvolatile memory in order to back up individual sets of update firmware, each of which corresponds to a unit mountable on the transmitting apparatus. Alternatively, the transmitting apparatus needs to acquire update firmware from an operation system (OpS) via a network in each firmware update.

There have been proposed technologies in which, prior to downloading software, a server transmits an environment search agent to a client to investigate the environment of the client, thereby enabling downloading of a program suitable for the system environment of the client. See, for example, Japanese Laid-open Patent Publications Nos. 08-263409 and 2004-310288.

### SUMMARY

In one aspect of the embodiments, there is provided a transmission system including a first transmitting apparatus connected to a network and a second transmitting apparatus connected to the network. The first transmitting apparatus includes: a receiver to acquire distribution data from another network, the distribution data including a plurality of update data sets for updating the first transmitting apparatus and the second transmitting apparatus and update data attribute information of the update data sets; and a memory to store the update data attribute information and the update data sets. The second transmitting apparatus includes: a processor to determine necessity of acquisition with respect to each of the update data sets stored in the first transmitting apparatus based on the update data attribute information acquired from the first transmitting apparatus and information which enables identifying necessity of each of the update data sets in the second transmitting apparatus; a receiver to acquire, from the first transmitting apparatus, one or more of the update data sets, for which the necessity of acquisition is affirmatively determined; and a memory to store the acquired update data sets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a transmission system according to a first embodiment;

FIG. 2 illustrates an example of a network configuration according to a second embodiment;

FIG. 3 illustrates an example of a node configuration according to the second embodiment;

FIG. 4 illustrates an example of a hardware configuration of a server node according to the second embodiment;

FIG. 5 illustrates a flow of update data from a file server to a client node according to the second embodiment;

FIG. 6 is a flowchart of a distribution data acquisition process according to the second embodiment;

FIG. 7 illustrates an example of a distribution data attribute list according to the second embodiment;

FIG. 8 illustrates an example of an update data attribute list according to the second embodiment;

FIG. 9 is a flowchart of an update data acquisition process according to the second embodiment;

FIG. 10 is a flowchart of an acquisition priority list generation process according to the second embodiment;

FIG. 11 illustrates data flows during the acquisition priority list generation process according to the second embodiment;

FIG. 12 illustrates an example of a configuration of the client node according to the second embodiment;

FIG. 13 illustrates an example of unit information according to the second embodiment;

FIG. 14 illustrates an example of a firmware list according to the second embodiment; and

FIG. 15 illustrates a procedure of notifying a server node to a client node according to a third embodiment.

### DESCRIPTION OF EMBODIMENTS

An Operating System (OpS) may be connected to a different network other than a network to which individual transmitting apparatuses are connected. For example, communication between the OpS and each transmitting apparatus may be operated using a charging network or a network whose communication band (frequency range) is shared with other devices. In the case of using such a network, file transfer may be limited to a specific period of time during a maintenance window, or may require attention to be given to the volume of communications traffic in consideration of network load and cost.

As functions required for transmitting apparatuses have grown more diverse, update data (for example, update firmware) that each transmitting apparatus needs to store in a nonvolatile memory has dramatically increased in size in recent years. In addition, in the present circumstances, the number of units to be supported by a transmitting apparatus continues to increase as a new version of the transmitting apparatus is released repeatedly. Accordingly, transmitting apparatuses are required to have a higher capacity nonvolatile memory. However, it is not realistic to replace nonvolatile memories of all transmitting apparatuses in terms of monetary costs, human costs, and the like. Further, the need of backing up sets of update data, which individually correspond to units mountable on a transmitting apparatus, is one reason why the transmitting apparatus needs to be equipped with a high capacity nonvolatile memory. However, the combination or the number of units making up each transmitting apparatus is limited, and therefore, it is often the case that transmitting apparatuses unnecessarily store, in the nonvolatile memories, sets of update data not to be used.

Several embodiments will be described below with reference to the accompanying drawings, wherein like reference numerals refer to like elements throughout.

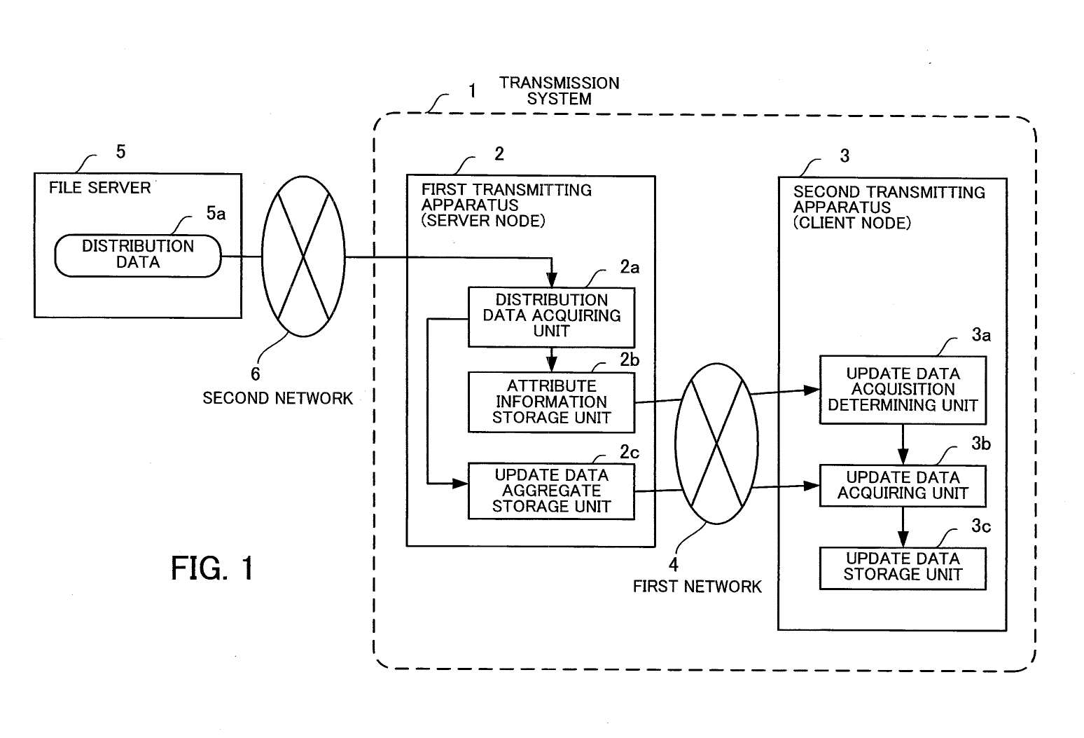

FIG. 1 is a functional block diagram of a transmission system according to a first embodiment. A transmission system 1 includes a first transmitting apparatus 2, a second transmitting apparatus 3, and a first network 4 connecting the first transmitting apparatus 2 and the second transmitting apparatus 3. The first transmitting apparatus 2 and the second transmitting apparatus 3 transmit information to each other via the first network 4.

The first transmitting apparatus 2 is connected to a file server 5 via a second network 6 so as to communicate with each other, and with this, the transmission system 1 is capable of acquiring distribution data 5a from the file server 5. The distribution data 5a is a library file formed in distribution format by compressing and packaging multiple sets of update data (update data aggregate) and attribute information of the update data sets. The update data sets are, for example, used to update software of the first transmitting apparatus 2 and the second transmitting apparatus 3. Note that the first transmitting apparatus 2 acquires the distribution data 5a from the file server 5, for example, using a data communication channel (outbound communication) of the second network 6.

The first transmitting apparatus 2 includes distribution data acquiring unit 2a, attribute information storage unit 2b, and update data aggregate storage unit 2c. The distribution data acquiring unit 2a acquires the distribution data 5a from the file server 5 via the second network 6. Note that the distribution data 5a is prepared with respect to each system configuration of the transmission system 1, and further, there are multiple versions of the distribution data 5a due to revisions. Therefore, the distribution data acquiring unit 2a acquires the latest version of the distribution data 5a which corresponds to the transmission system 1.

The attribute information storage unit 2b stores update data attribute information obtained by analyzing the distribution data 5a. Note that the update data attribute information includes, for example, update data name, update data version, and update data checksum.

In addition, the attribute information storage unit 2b stores the update data attribute information, for example, in a nonvolatile storage medium, such as an electrically erasable and programmable read only memory (EEPROM), a flash memory, and a flash-memory type memory card. The update data aggregate storage unit 2c stores an update data aggregate (i.e., a collection of update data sets) obtained by analyzing the distribution data 5a. Each update data set is data for updating a program or firmware, for example, and corresponds to one update file. In addition, the update data aggregate storage unit 2c stores the update data aggregate, for example, in a nonvolatile storage medium, such as an EEPROM, a flash memory, and a flash-memory type memory card.

The second transmitting apparatus 3 includes update data acquisition determining unit 3a, update data acquiring unit 3b, and update data storage unit 3c. The update data acquisition determining unit 3a determines the necessity of acquisition with respect to each update data set for the update data aggregate stored in the first transmitting apparatus 2. This determination is made based on the update data attribute information acquired from the first transmitting apparatus 2 and information which enables identifying the necessity of each update data set in the second transmitting apparatus 3. Note here that the information which enables identifying the necessity of each update data set in the second transmitting apparatus refers to, for example, information which enables identifying units (components) making up the second transmitting apparatus 3, more specifically, information indicating a combination of units making up the second transmitting apparatus 3. For instance, the update data acquisition determining unit 3a determines that acquisition of an update data set is necessary in the case where the update data set stored in the first transmitting apparatus 2 corresponds to a unit of the second transmitting apparatus 3 and is determined as a revision (i.e., revised update data set) based on the update data attribute information. Then, the update data acquiring unit 3b acquires, from the first transmitting apparatus 2, the update data set for which the update data acquisition determining unit 3a has determined affirmatively the necessity of acquisition. The update data storage unit 3c stores the update data set acquired by the update data acquiring unit 3b. For example, the update data storage unit 3c stores the update data set in a nonvolatile storage medium, such as an EEPROM, a flash memory, and a flash-memory type memory card.

Note that the first transmitting apparatus 2 and the second transmitting apparatus 3 perform communication of the update data attribute information and the update data set, for example, using a control channel (inbound communication) of the first network 4. Thus, in the transmission system 1 in which the first transmitting apparatus 2 stores the update data aggregate and the second transmitting apparatus 3 acquires the necessary update data set, the first transmitting apparatus 2 functions as a server node and the second transmitting apparatus 3 functions as a client node. Note that the transmission system 1 may have not one but multiple client nodes. Similarly, the transmission system 1 may have not one but multiple server nodes.

With the transmission system 1 described above, it is possible to reduce the load on the second network 6 at the time of acquiring the distribution data 5a used for updating the software of the first transmitting apparatus and the second,transmitting apparatus 3. Accordingly, even in the case where the use of the second network 6 is charged, the communication cost is reduced. In addition, even in the case where communication is operated as the communication band of the second network 6 is shared with other devices, it is easy to prevent excessive load from being imposed on the second network 6 by performing communication at a specific period of time during a maintenance window. In addition, if the server node is provided with a storage capacity sufficient to store multiple update data sets required in the transmission system 1, the client node only has to have a storage capacity sufficient to store update data sets that the client node requires.

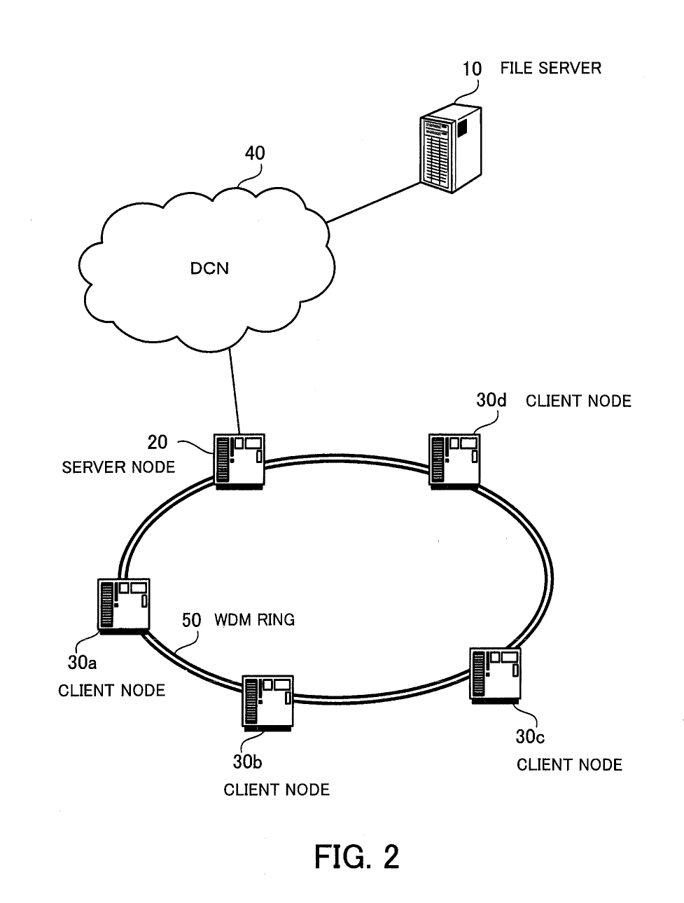

Next provided is a more specific description using a second embodiment. First, a network forming a transmission system and a network connecting a file server and the transmission system are described. FIG. 2 illustrates an example of a network configuration of the second embodiment. A file server 10 is a component of an OpS which supports maintenance and operation of the transmission system, and is connected to a data communication network (DCN) 40. A server node 20 and client nodes 30a, 30b, 30c, and 30d are, for example, optical add-drop multiplexers (OADMs) or in-line amplifiers (ILAs). The server node 20 and the client nodes 30a, 30b, 30c, and 30d make up a wavelength division multiplexing (WDM) ring 50. The WDM ring 50 serves, for example, as a high-speed backbone of a network of a telecommunications carrier and provides transmission of data. Accordingly, the server node 20 and the client nodes 30a, 30b, 30c, and 30d are regarded as transmitting apparatuses, and make up a transmission system together with the WDM ring 50. The server node 20 is connected to the file server 10 via the DCN 40 in such a manner as to communicate with each other, and performs communication with the file server 10 using a data communication channel of the DCN 40. In addition, the server node 20 performs data transmission with the client nodes 30a, 30b, 30c, and 30d via the WDM ring 50. The data transmission performed by the server node 20 uses a control channel which is allocated to one wavelength among multiple wavelengths. Through the control channel, the file server 10 communicates update data to the client nodes 30a, 30b, 30c, and 30d. Note that it is configured to use the control channel for the update data communication so that the update data communication does not impose load on bands for data communication of the transmission system. However, a data communication channel may be used for the update data communication by employing an overhead of a Synchronous Optical Network (SONET) fixed frame. For example, general communication channel 0 (GCCO) in the G.709 optical transport network (OTN) frame may be used.

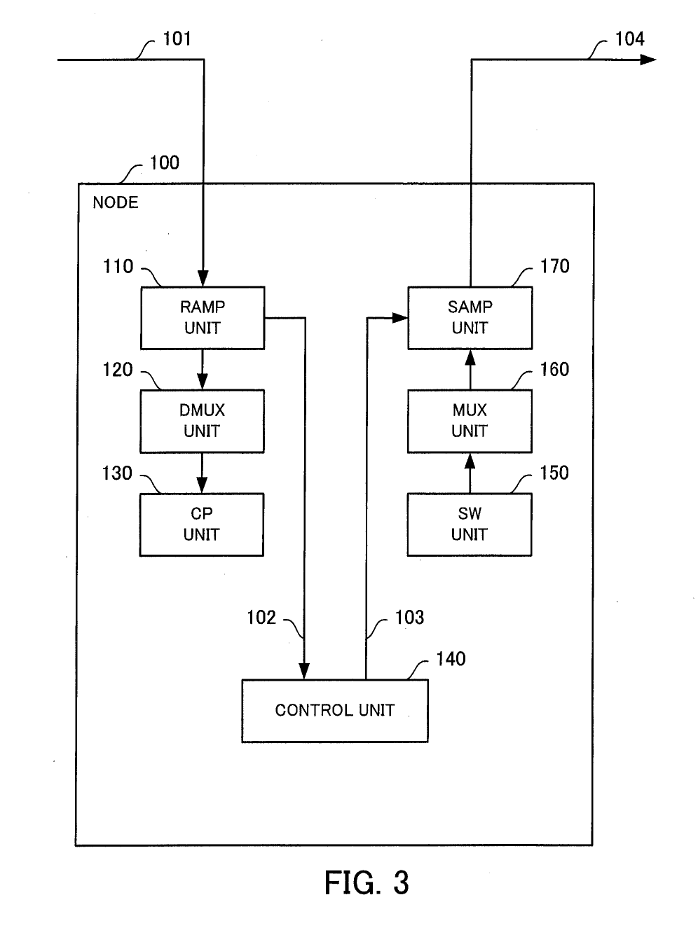

Next, described are unit configurations of the server node 20 and the client nodes 30a, 30b, 30c, and 30d according to the second embodiment. FIG. 3 illustrates an example of a node configuration according to the second embodiment. A node (transmitting apparatus) 100 is an example in the case where the server node 20 and the client nodes 30a, 30b, 30c, and 30d are OADMs. The node 100 includes a receiver amplifier (RAMP) unit 110, a demultiplexer (DMUX) unit 120, a coupler (CP) unit 130, a control unit 140, a switch (SW) unit 150, a multiplexer (MUX) unit 160, and a sender amplifier (SAMP) unit 170. The RAMP unit 110 is connected to a WDM line 101, and outputs a control channel allocated wavelength 102 of a received optical signal to the control unit 140. Note here that the control channel allocated wavelength 102 is a wavelength, within the received optical signal, to which a control channel has been allocated. In addition, the RAMP unit 110 amplifies the optical signal and outputs the amplified optical signal to the DMUX unit 120. The DMUX unit 120 demultiplexes the optical signal which is formed by multiplexing and outputs the demultiplexed optical signals to the CP unit 130. The CP unit 130 selects through light and drop light from the demultiplexed optical signals. The control unit 140 exercises overall control over the node 100. The control unit 140 inputs the control channel allocated wavelength 102 from the RAMP unit 110, and outputs, to the SAMP unit 170, a control channel allocated wavelength 103, to which a control channel has been allocated. The SW unit 150 selects the through light and adds light from the demultiplexed optical signals. The MUX unit 160 multiplexes the demultiplexed optical signals and outputs the multiplexed signal to the SAMP unit 170. The SAMP unit 170 is connected to a WDM line 104, and outputs the optical signal input from the MUX unit 160 and the control channel allocated wavelength 103 together. In the node 100 configured in such a manner, the control unit 140 transmits and receives update data using the control channel allocated wavelengths 102 and 103. Note that since the node 100 is configured in such a manner that individual units making up the node 100 are exchangeable, addable, and deletable, each node may have a different configuration. Accordingly, update data required by individual nodes may be different.

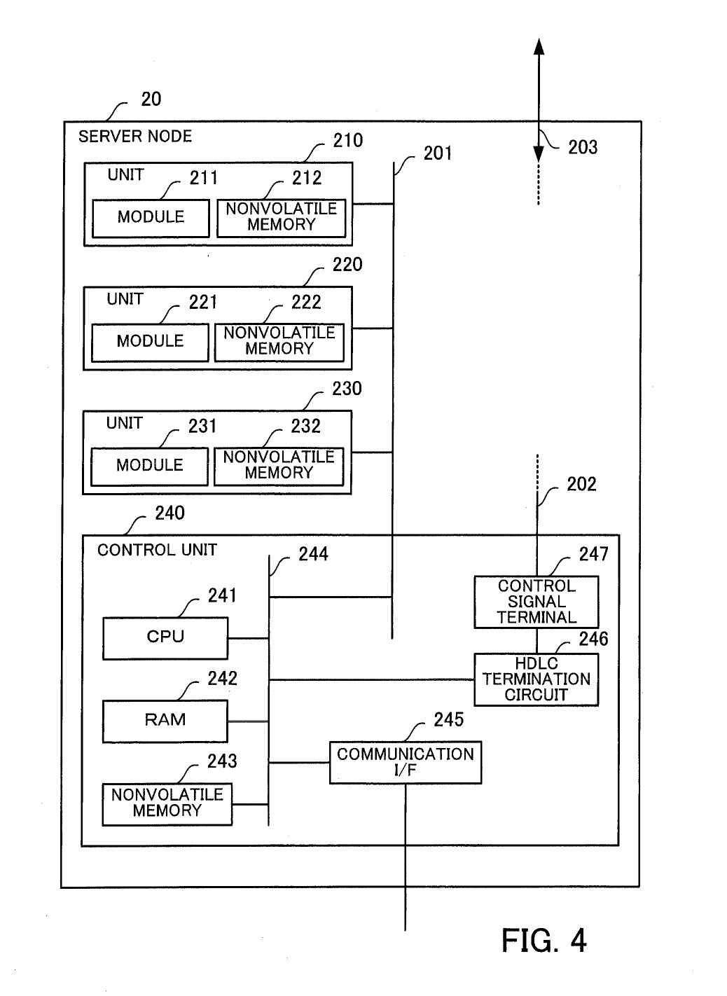

Next, described is an example of a hardware configuration of the node 100 according to the second embodiment in the case where the node 100 is a server node. Note that various combinations are possible for units making up the node 100, and therefore, in the example illustrated below, the individual units are referred to as simply “units” without specific terms. FIG. 4 illustrates an example of a hardware configuration of the server node according to the second embodiment. The server node 20 includes a control unit 240 and multiple units 210, 220, and 230. The units 210, 220, and 230 are individually connected to a bus 201. The control unit 240 outputs control signals to the units 210, 220, and 230, and detects alarm signals of the units 210, 220, and 230. The whole control unit 240 is controlled by a central processing unit (CPU) 241. To the CPU 241, a random access memory (RAM) 242, nonvolatile memory 243, a communication interface 245, a high-level data link control (HDLC) termination circuit 246, and the bus 201 are connected via a bus 244. In the RAM 242, at least a part of application programs to be executed by the CPU 241 is temporarily stored, which allows the server node 20 to serve as a transmitting apparatus and a server. The RAM 242 also stores various types of data required for processing performed by the CPU 241. The nonvolatile memory 243 stores an update data attribute list and an update data aggregate to be distributed to client nodes and the units 210, 220, and 230 in addition to the application programs to be executed by the CPU 241. Thus, the nonvolatile memory 243 stores update data other than update data required for the server node 20 to function only as a transmitting apparatus. Accordingly, the nonvolatile memory 243 needs to have a larger storage capacity compared to nonvolatile memories of the client nodes. The communication interface 245 is connected to the DCN 40. The communication interface 245 performs data transmission and reception with the file server 10 via the DON 40. The HDLC termination circuit 246 is connected to a control signal terminal 247, and performs data transmission and reception using a section data communication channel (SDCC). The control signal terminal 247 inputs and outputs a control channel allocated wavelength 202, to which a control channel has been allocated. The server node 20 is connected to a WDM line 203, and performs transmission and reception of data, including update data, with the client nodes (not illustrated) through a control channel. The units 210, 220, and 230 include modules 211, 221, and 231, respectively, each of which is a field programmable gate array (FPGA), a digital signal processor (DSP), or the like. Also, the units 210, 220, and 230 include nonvolatile memories 212, 222, and 232, respectively, each of which stores firmware of the corresponding module. The CPU 241 is capable of writing firmware (update data) to each of the nonvolatile memories 212, 222, and 232 via the buses 244 and 201. Thus, the CPU 241 rewrites firmware stored in each of the nonvolatile memories 212, 222, and 232, with the result that the units 210, 220, and 230 respectively achieve firmware updates. The description has been given of the server node 20, however, the client nodes 30a, 30b, 30c, and 30d also have hardware configurations similar to that of the server node 20 described above, except that the storage capacity of the nonvolatile memory 243 does not have to be very large and the communication interface 245 is not necessarily required. In other words, the server node 20 needs to be equipped with the nonvolatile memory 243, the storage capacity of which is sufficiently large to store the distribution data, and needs to have the communication interface 245.

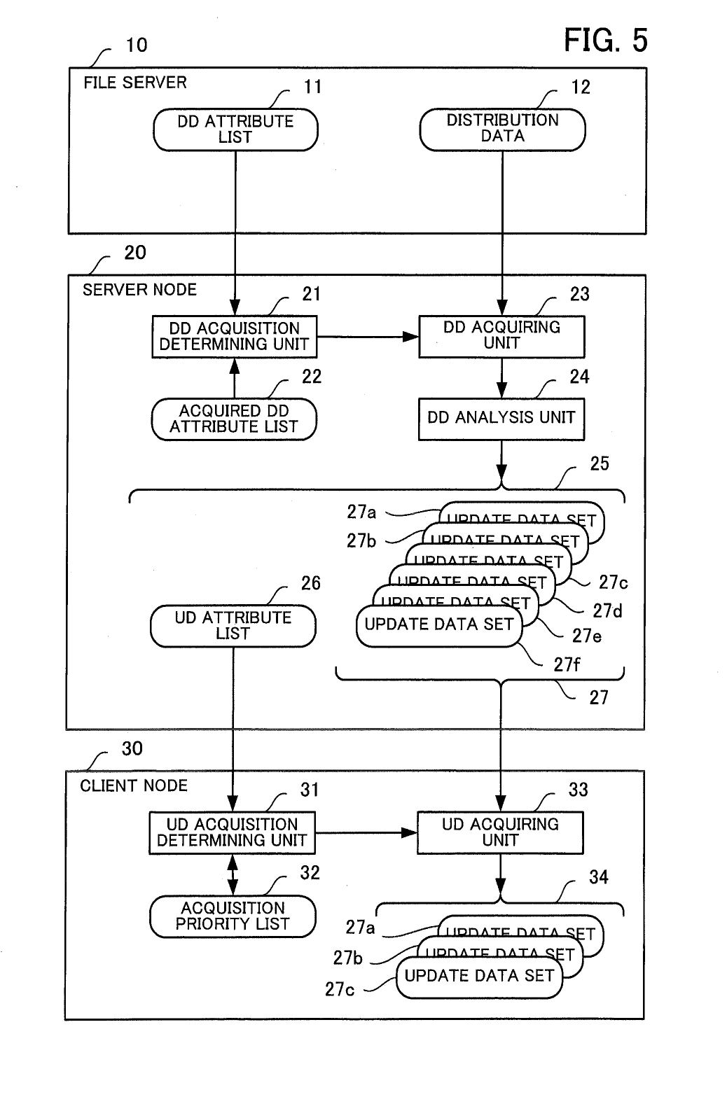

Next described is a flow of update data from a file server to a client node according to the second embodiment. FIG. 5 illustrates the flow of update data from the file server to the client node according to the second embodiment. When distribution data (library file) 12 is revised, the distribution data 12 is uploaded to the file server 10 together with a distribution data (DD) attribute list 11. The distribution data attribute list 11 is a list including information (for example, file name, version number, and file size) used for determining the necessity of acquiring the distribution data 12 and information (for example, checksum) of the distribution data 12 itself. The server node 20 distributes the distribution data 12 and the distribution data attribute list 11 using a file transfer protocol, such as a file transfer protocol (FTP) and a file transfer access and management (FTAM). The distribution data attribute list 11 is stored, for example, in a distribution data attribute list storage unit (not illustrated) of the file server 10. The distribution data 12 is stored, for example, in a distribution data storage unit (not illustrated) of the file server 10.

A distribution data (DD) acquisition determining unit 21 of the server node 20 acquires the distribution data attribute list 11 from the file server 10. The distribution data acquisition determining unit 21 determines the necessity of acquiring the distribution data 12 by comparing an already acquired distribution data attribute list (an acquired distribution data (DD) attribute list 22) and the distribution data attribute list 11 acquired from the file server 10. For example, the distribution data acquisition determining unit 21 checks whether a revision has been made to the distribution data 12 by comparing version information in the acquired distribution data attribute list 22 and version information in the distribution data attribute list 11, and determines that it is necessary to acquire the distribution data 12 if a revision has been made. In the case where the distribution data acquisition determining unit 21 determines that it is necessary to acquire the distribution data 12, a distribution data (DD) acquiring unit 23 acquires the distribution data 12 from the file server 10. A distribution data (DD) analysis unit 24 analyzes the distribution data 12 acquired by the distribution data acquiring unit 23. The distribution data is a library file formed in distribution format by compressing and packaging an update data aggregate 27 and attribute information of the update data aggregate 27 (an update data (UD) attribute list 26). The update data aggregate 27 includes update data sets 27a, 27b, . . . , and 27f. The distribution data analysis unit 24 obtains a data aggregate 25 by analyzing the distribution data 12, thereby obtain the update data attribute list 26 and the update data aggregate 27. The update data aggregate 27 includes, for example, firmware for the modules 211, 221, and 231 included in the units 210, 220, and 230, respectively. The update data attribute list 26, the details of which are described below, includes information on the update data sets 27a, 27b, . . . , and 27f. The update data attribute list 26 is stored, for example, in an update data attribute list storage unit (not illustrated) of the server node 20. The update data sets 27a, 27b, and 27f are stored, for example, in a distribution data storage unit (not illustrated) of the server node 20.

An update data (UD) acquisition determining unit 31 of a client node 30 acquires the update data attribute list 26 from the server node 20. The update data acquisition determining unit 31 generates an acquisition priority list 32 from the update data attribute list 26. The acquisition priority list 32 is a list of update data sets that the client node 30 needs to acquire. The update data acquisition determining unit 31 determines the necessity of acquiring each update data set by comparing the generated acquisition priority list 32 and update data sets stored in the client node 30. For example, the update data acquisition determining unit 31 checks whether a revision has been made to the distribution data 12 by comparing, among release information, version information. If a revision has been made, the update data acquisition determining unit 31 determines that it is necessary to acquire individual update data sets. The acquisition priority list 32 and processing of generating the acquisition priority list 32 are described later. In the case where the update data acquisition determining unit 31 determines that it is necessary to acquire individual update data sets, an update data (UD) acquiring unit 33 acquires the update data sets from the server node 20. According to the example illustrated in FIG. 5, the update data acquiring unit 33 acquires the update data sets 27a, 27b, and 27c, which form a partial data aggregate 34 of the update data aggregate 27.

In this manner, file transfer is carried out in two steps, that is, acquisition of the distribution data from the file server 10 to the server node 20 and acquisition of the update data sets from the server node 20 to the client node 30. With this, the client node 30 does not have to make a direct access to the file server 10. In addition, the client node 30 does not have to be equipped with a nonvolatile memory having a large storage capacity compared to the nonvolatile memory of the server node 20. Therefore, it is possible to reduce the storage capacity of the nonvolatile memory in the client node 30.

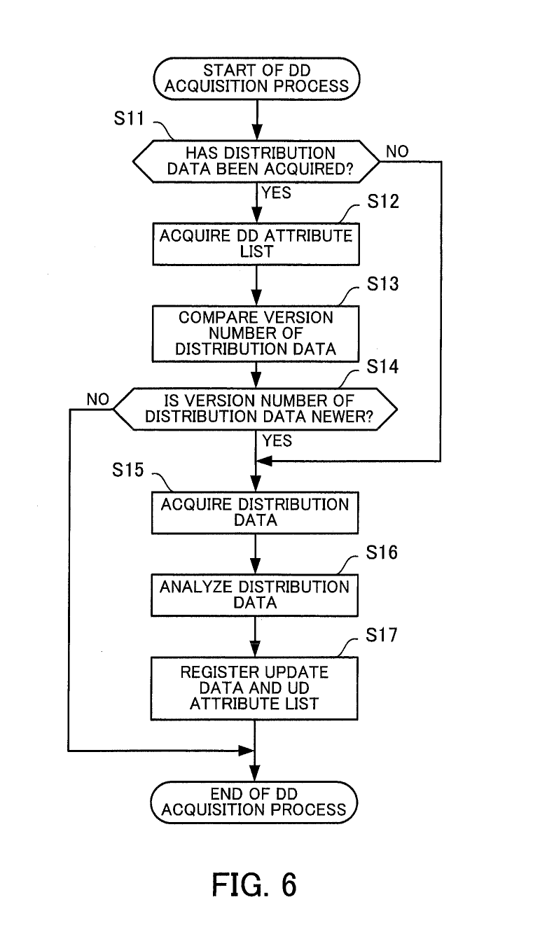

Next, described is a distribution data (DD) acquisition process performed by the server node 20 according to the second embodiment. FIG. 6 is a flowchart of the distribution data acquisition process according to the second embodiment. The server node 20 performs the distribution data acquisition process on a regular basis (for example, once a day). Note that the distribution data acquisition process may be performed using, as event triggers, start-up of the server node 20, reception of a request for the update data attribute list 26 from the client node 30, and the like.

[Step S11] The server node 20 determines whether to have acquired the distribution data 12. The process proceeds to Step S12 if the server node 20 has already acquired the distribution data 12, and proceeds to Step S15 if the server node 20 has not yet acquired the distribution data 12. Whether the distribution data 12 has already been acquired may be determined by, for example, whether the distribution data 12 is stored in a nonvolatile memory of the server node 20. Alternatively, the determination may be made based on whether, not the distribution data 12, but the update data aggregate 27 obtained by analyzing the distribution data 12 is stored. In addition, the determination may, alternatively, be made with reference to the history of acquiring the distribution data 12.

[Step S12] The server node 20 requests the distribution data attribute list 11 from the file server 10. The server node 20 is able to specify the file server based on information preliminarily set in a server table. Communication between the server node 20 and the file server 10 is achieved by a file transfer protocol, such as FTP. In this case, the file server 10 is a FTP server, and the server node 20 is a FTP client. The server node 20 acquires the distribution data attribute list 11, which is transmitted by the file server 10 after reception of the request for the distribution data attribute list 11 from the server node 20.

[Step S13] The server node 20 compares the version number of the distribution data attribute list 11 acquired from the file server 10 and the version number of the acquired distribution data attribute list 22 stored in the server node 20.

[Step S14] If the version number of the distribution data attribute list 11 is newer than the version number of the acquired distribution data attribute list 22, the server node 20 determines that it is necessary to acquire the distribution data 12 from the file server 10. On the other hand, if the version number of the distribution data attribute list 11 is not newer than the version number of the acquired distribution data attribute list 22, the server node 20 determines that it is not necessary to acquire the distribution data 12 from the file server 10. When the server node 20 determines that the acquisition of the distribution data 12 is not necessary, the distribution data acquisition process is ended. On the other hand, when the server node 20 determines that the acquisition of the distribution data 12 is necessary, the process proceeds to Step S15.

[Step S15] The server node 20 requests the distribution data 12 from the file server 10. The server node 20 acquires the distribution data 12, which is transmitted by the file server 10 after reception of the request for the distribution data 12 from the server node 20.

[Step S16] The server node 20 analyzes the library file formed in distribution format by compressing and packaging the update data aggregate 27 and the update data attribute list 26.

[Step S17] The server node 20 stores the obtained update data aggregate 27 (image data aggregate including the update data sets 27a, 27b, . . . , and 27f) and update data attribute list 26 in a nonvolatile memory, and registers the update data aggregate 27 and the update data attribute list 26 to itself as data for distribution to the client nodes (i.e., server registration).

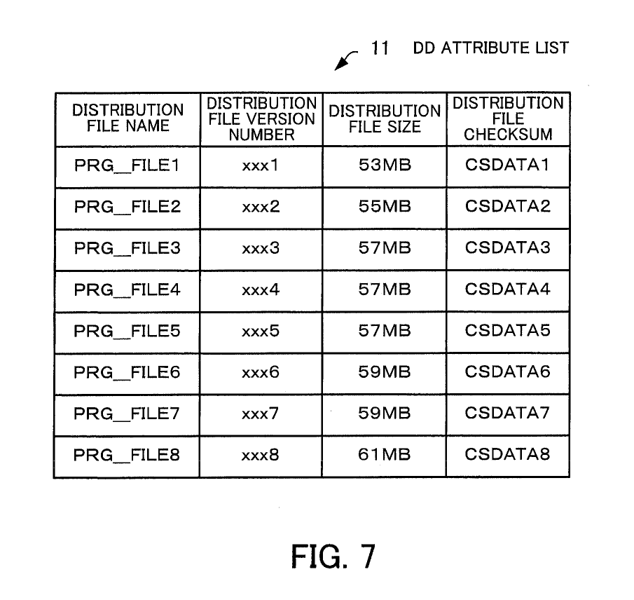

Next described is the distribution data attribute list 11 acquired by the server node 20 according to the second embodiment. FIG. 7 illustrates an example of the distribution data attribute list according to the second embodiment. To serve as information based on which the necessity of acquiring the distribution data 12 is determined, the distribution data attribute list 11 includes distribution file name, distribution file version number, distribution file size, and distribution file checksum as information of the distribution data 12 itself. Each distribution file name is a file name of the distribution data 12, and is used by the transmission system including the server node 20 to identify a necessary distribution file. Each distribution file version number is used to identify a version number of the corresponding distribution file. Each distribution file size is used to identify a storage capacity required by the server node 20 to store the corresponding distribution file. Each distribution file checksum is used to detect errors in the corresponding distribution file acquired by the server node 20.

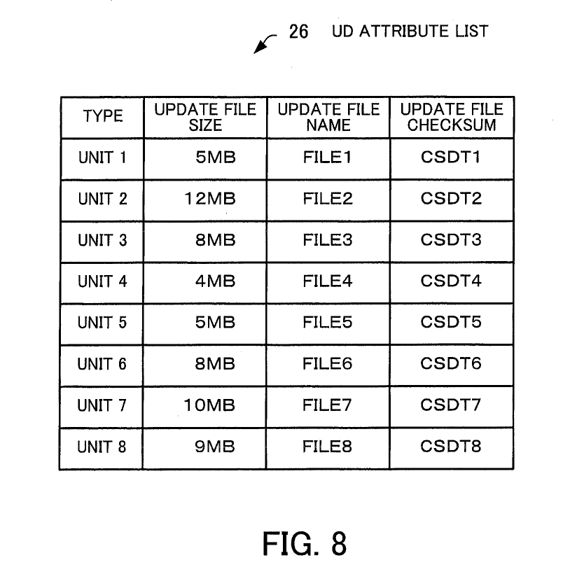

Next described is the update data attribute list 26 acquired by the server node 20 according to the second embodiment. FIG. 8 illustrates an example of the update data attribute list according to the second embodiment. The update data attribute list 26 includes type, update file size, update file name, and update file checksum. Each type is information for identifying a unit. Each update file size is used to identify a storage capacity required by the client node 30 to store the corresponding update file. Each update file name is used to identify the corresponding update file. Each update file checksum is used to detect errors in the corresponding update file acquired by the client node 30. Note that the update data attribute list 26 may include other information, such as update file version number. In that case, each update file version number is used to identify a version number of the corresponding update file.

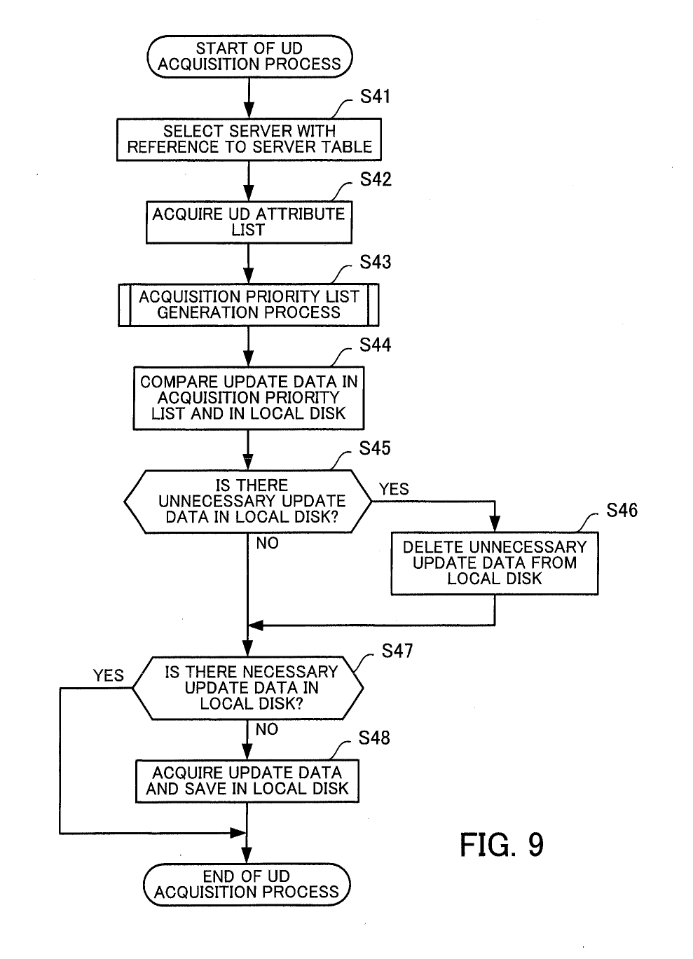

Next described is an update data acquisition process performed by the client node 30 according to the second embodiment. FIG. 9 is a flowchart of the update data acquisition process according to the second embodiment. The client node 30 performs the update data acquisition process at the time when a change in the unit configuration of the client node 30 is detected. Note that the update data acquisition process may be performed using, for example, start-up of the client node 30 as an event trigger, or may be performed on a regular basis (for example, once a day).

[Step S41] With reference to a server table, the client node 30 selects the server node 20 from which update data is acquired. The server table is table data in which information used to make connection to the server node 20 is recorded. The information for connecting to the server node 20 includes, for example, address information, used protocol, and credentials of the server node 20. In the case where there are multiple server nodes, the server table may include multiple sets of information used to make connection to individual server nodes. In this case, a connection priority order may be assigned to each server node, or an appropriate server node may be selected according to a connection environment (for example, communication time, or random connection). The server table is, for example, stored in a nonvolatile storage area of the client node 30 at the time of configuration of the transmission system. Note that the server table stored by the client node 30 may be updated on a regular or irregular basis.

[Step S42] The client node 30 acquires the update data attribute list 26 from the server node 20.

[Step S43] The client node 30 generates the acquisition priority list 32 based on the update data attribute list 26 acquired from the server node 20 and other information. The generation of the acquisition priority list 32 is described below in detail as an acquisition priority list generation process.

[Step S44] The client node 30 compares update data sets recorded in the acquisition priority list 32 and update data sets stored in a local disk (nonvolatile memory) of the client node 30.

[Step S45] By the comparison in Step S44, the client node 30 determines whether one or more unnecessary update data sets are stored in the local disk. In the case where one or more update data sets which are not recorded in the acquisition priority list 32 are stored in the local disk, the client node 30 determines that unnecessary update data sets are stored in the local disk and, the process then proceeds to Step S46. On the other hand, in the case where no unnecessary update data set is stored in the local disk, the process proceeds to Step S47.

[Step S46] The client node 30 deletes the unnecessary update data sets from the local disk. With this deletion, the client node 30 increases the amount of free space on the local disk.

[Step S47] By the comparison of the update data sets recorded in the acquisition priority list 32 and the update data sets stored in the local disk, the client node 30 determines whether one or more necessary update data sets are stored in the local disk. In the case where the client node 30 determines that the necessary update data sets are stored in the local disk, the update data acquisition process is ended. On the other hand, in the case where one or more update data sets stored in the acquisition priority list 32 are not stored in the local disk, the client node 30 determines that necessary update data sets are not stored in the local disk, and the process then proceeds to Step S48.

[Step S48] The client node 30 acquires the necessary update data sets from the server node 20. The client node 30 stores, in the local disk, the update data sets acquired from the server node 20 and, the update data acquisition process is then ended.

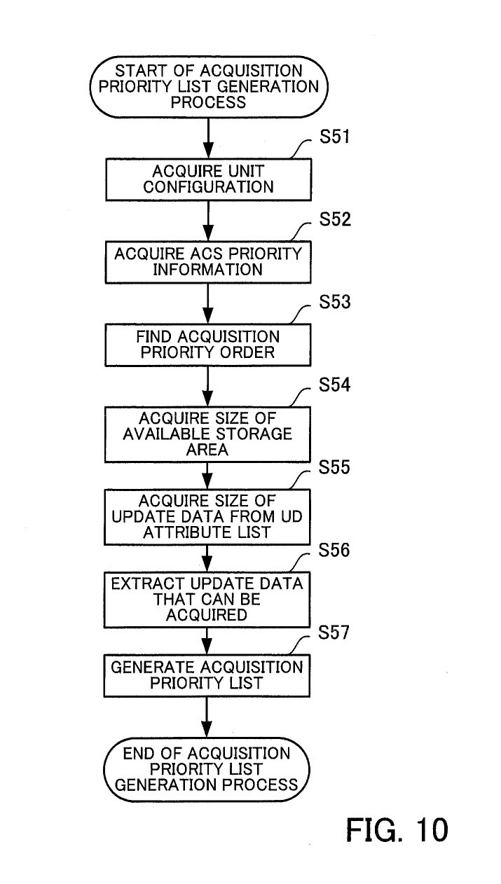

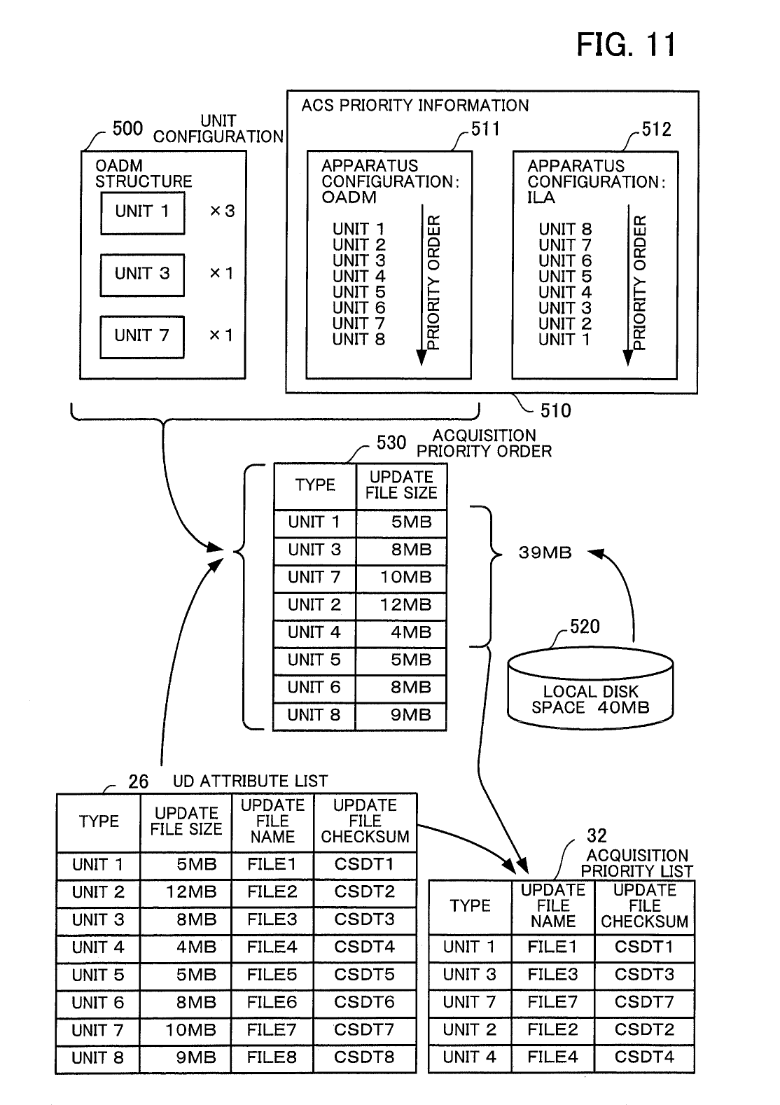

Next described is the acquisition priority list generation process performed by the client node 30 according to the second embodiment. FIG. 10 is a flowchart of the acquisition priority list generation process according to the second embodiment. FIG. 11 illustrates a data flow during the acquisition priority list generation according to the second embodiment. The client node 30 performs the acquisition priority list generation process during performing the update data acquisition process.

[Step S51] The client node 30 acquires a unit configuration 500. The unit configuration 500 includes configuration information of one or more units (type and number of components) making up the client node 30 and apparatus information of an apparatus formed by those units (category of the apparatus formed by the units). For example, the unit configuration 500 includes, as the apparatus information, information indicating an OADM structure and, as the configuration information, information indicating that there are three sets of Unit 1, one set of Unit 3, and one set of Unit 7. With the unit configuration 500, it is understood that, for example, the client node 30 is an OADM including three sets of Unit 1, one set of Unit 3, and one set of Unit 7. The unit configuration 500 is stored, for example, in a nonvolatile storage area of the client node 30 at the time of configuration of the transmission system.

[Step S52] The client node 30 acquires apparatus configuration-specific (ACS) priority information 510. The ACS priority information 510 includes information provided with respect to each apparatus configuration category and recording an acquisition priority order among individual units of the apparatus configuration category. For example, the ACS priority information 510 includes unit-specific acquisition (USA) priority order information 511 for an apparatus configuration of OADM; and USA priority order information 512 for an apparatus configuration of ILA. According to the USA priority order information 511, in the apparatus configuration of OADM, the highest priority is placed on Unit 1 and the lowest priority is placed on Unit 8. In addition, according to the USA priority order information 512, in the apparatus configuration of ILA, the highest priority is placed on Unit 8 and the lowest priority is placed on Unit 1. The ACS priority information 510 is stored, for example, in a nonvolatile storage area of the client node 30 at the time of configuration of the transmission system.

[Step S53] The client node 30 finds the acquisition priority order of individual units based on the unit configuration 500 and the ACS priority information 510. For example, the client node 30 determines, based on the unit configuration 500, that the apparatus configuration is an OADM. Further, the client node 30 finds, based on the USA priority order information 511, that Unit 1 has the highest priority order, followed by Unit 2, Unit 3, . . . , and Unit 8 in the stated order. Then, the client node 30 rearranges the priority order in such a manner that priorities of Unit 1, Unit 3, and Unit 7 making up the client node 30 become higher than those of units which are not components of the client node 30. With this rearrangement, the client node 30 obtains the priority order of individual units (order of Unit 1, Unit 3, Unit 7, . . . , and Unit 8) illustrated in an acquisition priority order 530 of FIG. 11.

[Step S54] The client node 30 acquires local disk space 520 which indicates the size of an available storage area. The client node 30 acquires, for example, 40 MB for the local disk space 520.

[Step S55] The client node 30 acquires, from the update data attribute list 26, the size of a storage area required to store an update file of each unit. With this acquisition, the client node 30 associates the type with the update file size in a manner illustrated in the acquisition priority order 530 of FIG. 11.

[Step S56] Based on the local disk space 520 and the size of the storage area required to store an update file of each unit, the client node 30 extracts update files which can be acquired from the server node 20 and stored. For example, in accordance with the size (40 MB) of the available storage area in the local disk, the client node 30 extracts, in the descending priority order, update files of individual units which can be stored in the local disk. In the example illustrated in FIG. 11, the client node 30 is able to store update files of Unit 1, Unit 3, Unit 7, Unit 2, and Unit 4 in the local disk since the sum total of the file sizes of these update files is 39 MB (i.e., the sum total is equal or less than the size of the available storage area in the local disk). Accordingly, the client node 30 extracts, among the update files of Unit 1 to Unit 8, the update files of Unit 1, Unit 3, Unit 7, Unit 2, and Unit 4 in the stated priority order.

[Step S57] The client node 30 generates the acquisition priority list 32, and the acquisition priority list generation process is then ended. In the acquisition priority list 32, the names of the update files extracted in Step S56 are individually associated with the types and the update file checksums, and are arranged in the order of priority of the update files to be acquired from the server node 20.

By acquiring update files from the server node according to the acquisition priority list 32, the client node 30 is able to prevent update files which are less likely to be used from being stored in the local disk, thereby preventing unnecessary consumption of the memory resources.

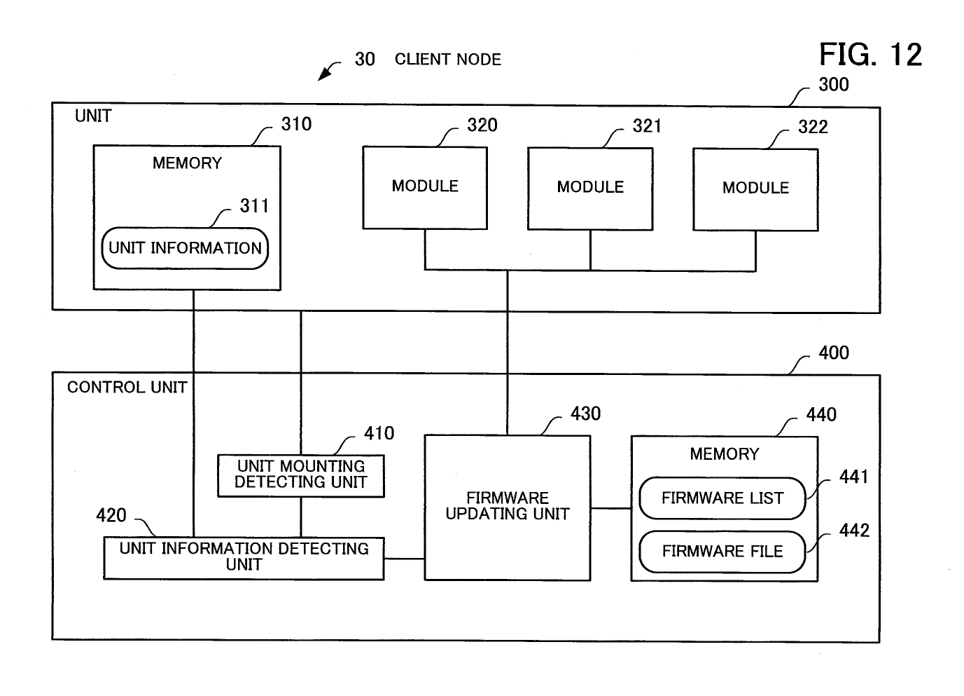

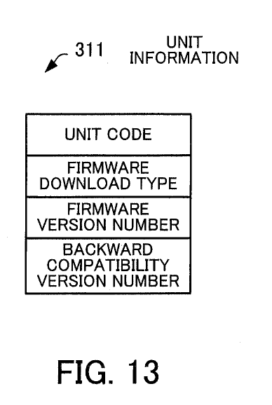

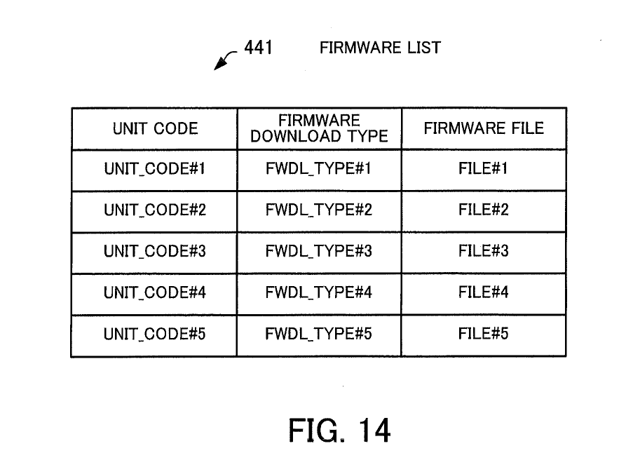

Next described are firmware updates for modules making up a unit of the client node according to the second embodiment. FIG. 12 illustrates an example of the configuration of the client node according to the second embodiment. FIG. 13 illustrates an example of unit information according to the second embodiment. FIG. 14 illustrates an example of a firmware list according to the second embodiment. The client node 30 includes a control unit (control section) 400 and a unit 300 as components. Here, since a description is given of a process performed between the control unit 400 and the unit 300, other units (except for the unit 300) making up the client node 30 are not illustrated in FIG. 12.

The control unit 400 includes a unit mounting detecting unit 410, a unit information detecting unit 420, and a firmware updating unit 430. The unit 300 includes a memory 310 and modules 320, 321, and 322. Note that the hardware configurations realizing the control unit 400, the unit 300, and the connection between the control unit 400 and the unit 300 may be the same as those in the server node 20 illustrated in FIG. 4.

The unit mounting detecting unit 410 detects mounting of the unit 300. The mounting of the unit 300 is detected, for example, using communication between the unit 300 and the control unit 400 or a connection signal transmitted from the unit 300. With the detection of the mounting of the unit 300, the control unit 400 detects a change in the configuration of the client node 30.

The unit information detecting unit 420 detects unit information 311 from the unit 300. The unit information 311 is stored in the memory (nonvolatile memory) 310 of the unit 300, for example, at the time of shipping. As illustrated in FIG. 13, the unit information 311 includes a unit code, a firmware download type, firmware version number, and a backward compatibility version number. The unit code is information specifying the type of the unit (for example, a MUX unit). The firmware download type is information specifying the configuration of the unit (for example, a hardware configuration). For example, in the case where the same MUX units have different hardware due to differences in time of market release or the like, those MUX units may require different firmware. By identifying the unit code and the firmware download type, the control unit 400 is able to identify firmware that the unit 300 needs to acquire. The firmware version number is information indicating a version number of corresponding firmware. The control unit 400 determines the necessity of a firmware update based on the version number of the firmware. The backward compatibility version number is information indicating compatibility with the control unit 400. Note that in the case where the control unit 400 determines to perform a firmware update or acquire new firmware, firmware (an update file) necessary for the client node 30 is acquired from the server node 20, as explained above.

A firmware file 442 which has been acquired by the control unit 400 from the server node 20 is stored with a firmware list 441 in a memory (nonvolatile memory) 440 of the control unit 400. The firmware list 441 is generated by the firmware updating unit 430 based on the acquisition priority list 32. As illustrated in FIG. 14, the firmware list 441 is a list in which unit codes, firmware download types, and firmware files (update files) are individually associated with each other. Each firmware file is identified with a unit code and a firmware download type. In the example of FIG. 14, the control unit 400 stores five firmware files 442 (for example, FILE#1, FILE#2, FILE#3, FILE#4, and FILE#5) in the memory 440. Note that each firmware file may be identified not with a firmware download type but with other information capable of identifying the firmware file.

The firmware updating unit 430 writes a firmware file corresponding to the unit 300 to nonvolatile memories (not illustrated) of the individual modules 320, 321, and 322. Note that the entire firmware file may be written to the individual nonvolatile memories of the modules 320, 321, and 322, or alternatively, parts of the firmware file which individually correspond to the modules 320, 321, and 322 may be written to the nonvolatile memories of the corresponding modules 320, 321, and 322. Each of the modules 320, 321, and 322 is, for example, a FPGA or a DSP, and operates according to the firmware written to the corresponding nonvolatile memory.

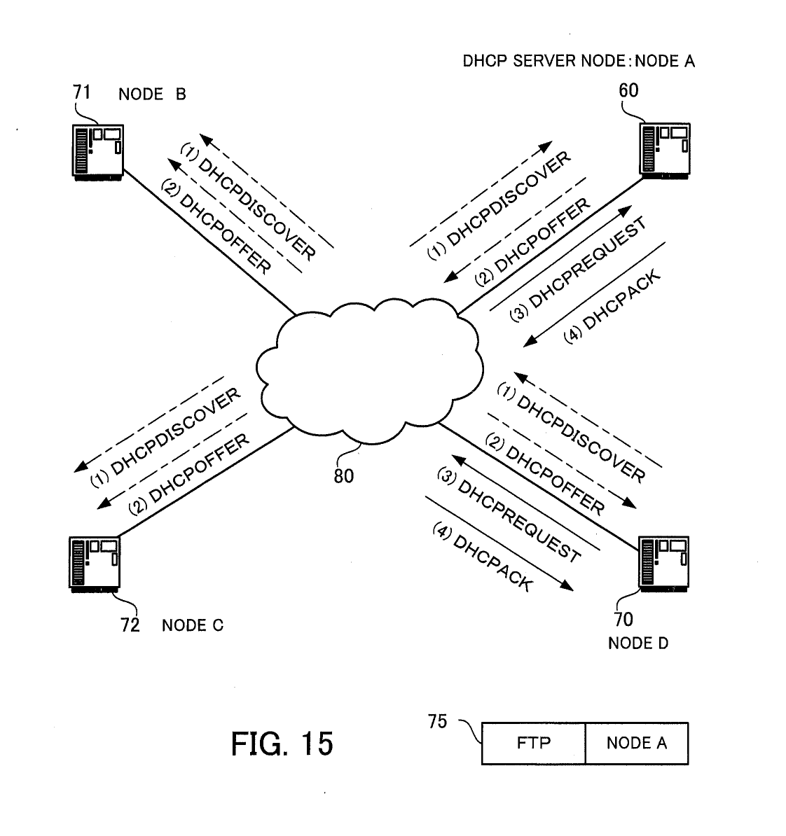

Next described is notification of a server node to a client node according to a third embodiment. FIG. 15 illustrates a procedure of notifying a server node to a client node according to the third embodiment. According to the third embodiment, the server node is notified to the client node in a network using a Dynamic Host Configuration Protocol (DHCP) server function, unlike in the case of the second embodiment in which a preliminarily set server table is used. Node A 60, Node B 71, and Node C 72 are connected to an IP network 80. Node D 70 which is newly connected to the IP network 80 broadcasts a DHCPDISCOVER message. On receiving the DHCPDISCOVER message, Node A 60 which is a DHCP server node broadcasts a DHCPOFFER message to thereby present an IP address of Node A to the Node D 70. Node D 70 broadcasts a DHCPREQUEST message indicating adoption of the presented IP address. On receiving the DHCPREQUEST message, Node A 60 (DHCP server node) broadcasts a DHCPACK message. On receiving the DHCPACK message, Node D 70 sets the received network information in itself. Note that Node B 71 and Node C 72 discard the broadcast messages which are not addressed to them. Node A 60 (DHCP server node) includes, in the DHCPACK message, an IP address of Node A 60 and information of a file transfer protocol that Node A 60 supports. Node D 70 stores the IP address and the file transfer protocol information by setting them in a server table 75. Thus, when a new client node is connected to the network (transmission system), the client node recognizes the server node and the file transfer protocol that the server node supports using the DHCP. Note that the same node may serve as both the DHCP server node and a server node which transfers update data, or different nodes individually serve as those server nodes. In addition, although the above description is given using an IP network as an example, the same procedure as the notification procedure using the DHCP can be used in other networks to notify a server node to a client node.

Note that the above-mentioned processing functions are achieved by a computer. In such a case, a program is provided in which process details of functions to be fulfilled by the file server 10, the server node 20, and the client node 30 are described. The program is executed on the computer, with the result that the above-mentioned processing functions are achieved on the computer. The program describing the process details may be recorded in computer-readable recording media (including portable recording media). The computer-readable recording media include magnetic recording devices, optical disks, magneto-optical recording media, and semiconductor memories. The magnetic recording devices include hard disk drives (HDDs), flexible disks (FDs), and magnetic tapes. The optical disks include digital versatile discs (DVDs), digital versatile disk random access memories (DVD-RAMs), compact disc read only memories (CD-ROMs), compact disc-recordables (CD-Rs), and compact disc-rewritables (CD-RWs). The magneto-optical recording media include magneto-optical disks (MOs).

In the case of distributing the program, portable recording media, such as DVDs and CD-ROMs, storing the program thereon, for example, are marketed. In addition, the program may be stored in a storage device of a server computer and then transferred from the server computer to another computer via a network.

The computer which executes the program stores, in its own storage device, the program recorded in such a portable recording medium or transferred from the server computer, and reads the program from the storage device and executes processes according to the program. Note that the computer may directly read the program from the portable recording medium and execute processes according to the program. In addition, each time a program is transferred from the server computer, the computer may sequentially execute processes according to the transferred program.

According to the above-described transmission system, a transmitting apparatus is able to store necessary update data even in the case where the transmitting apparatus does not have a large storage capacity. Further, it is possible to reduce load on a network in which the update data is communicated. In addition, according to the above-described transmitting apparatus, it is possible to store necessary update data even in the case where the transmitting apparatus does not have a large storage capacity. Further, it is possible to reduce load on a network in which the update data is communicated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A transmission system comprising:
a first transmitting apparatus connected to a network; and
a second transmitting apparatus connected to the network,
wherein the first transmitting apparatus includes:
a receiver to acquire distribution data from another network, the distribution data including a plurality of update data sets for updating the first transmitting apparatus and the second transmitting apparatus and update data attribute information of the update data sets;
a memory to store the update data attribute information and the update data sets, and
wherein the second transmitting apparatus includes:
a processor to determine necessity of acquisition with respect to each of the update data sets stored in the first transmitting apparatus based on the update data attribute information acquired from the first transmitting apparatus and information which enables identifying necessity of each of the update data sets in the second transmitting apparatus;
a receiver to acquire, from the first transmitting apparatus, one or more of the update data sets, for which the necessity of acquisition is affirmatively determined; and
a memory to store the acquired update data sets.

2. The transmission system according to claim 1, wherein:
the first transmitting apparatus further includes a processor to acquire distribution data attribute information of the distribution data from said another network and determine necessity of acquiring the distribution data; and
the receiver of the first transmitting apparatus acquires the distribution data from said another network based on a result of the determination made by the processor of the first transmitting apparatus.

3. The transmission system according to claim 2, wherein:
the memory of the first transmitting apparatus further stores the acquired distribution data attribute information; and
the processor of the second transmitting apparatus determines the necessity of acquiring the distribution data by comparing the distribution data attribute information acquired from said second network and the distribution data attribute information stored in the memory of the first transmitting apparatus.

4. The transmission system according to claim 1, wherein:
the first transmitting apparatus further includes a processor to analyze the acquired distribution, data to obtain the update data sets and the update data attribute information;
the update data attribute information stored in the memory of the first transmitting apparatus is updated with the obtained update data attribute information; and
the update data sets stored in the memory of the first transmitting apparatus is updated with the obtained update data sets.

5. The transmission system according to claim 1, wherein the processor of the second transmitting apparatus determines the necessity of acquisition in such a manner that total data size of the acquired update data sets falls within a storage capacity of the memory of the second transmitting apparatus.

6. The transmission system according to claim 1, wherein
the processor of the second transmitting apparatus generates an acquisition priority list that lists, among the update data sets stored in the memory of the first transmitting apparatus, one or more update data sets to be preferentially acquired, on the basis of the update data attribute information acquired from the first transmitting apparatus and the information which enables identifying necessity of each of the update data sets in the second transmitting apparatus, and determines, based on the acquisition priority list, the necessity of acquisition with respect to each of the update data sets stored in the memory of the first transmitting apparatus.

7. The transmission system according to claim 6, wherein:
the second transmitting apparatus includes one or more units; and
the processor of the second transmitting appartaus generates, according to an update data acquisition priority order, the acquisition priority list that lists one or more of the update data sets, total data size of which falls within a storage capacity of the memory of the second transmitting apparatus, the update data acquisition priority order being generated using, as a first priority, one or more of the update data sets which are used to individually update the units and, as a second priority, an update data, acquisition priority order set for an apparatus category to which the second transmitting apparatus belongs.

8. The transmission system according to claim 1, wherein:
communication between said another network and the first transmitting apparatus is performed using a data communication channel of said another network; and
communication between the first transmitting apparatus and the second transmitting apparatus is performed using a control channel of the network.

9. A transmitting apparatus for performing data transmission with a different transmitting apparatus through a network, the transmitting apparatus comprising:
a receiver configured to acquire distribution data from another network, the distribution data including a plurality of update data sets for updating the transmitting apparatus and the different transmitting apparatus and update data attribute information of the update data sets; and
a transmitter configured to transmit, to the different transmitting apparatus, the update data attribute information to be used by the different transmitting apparatus to determine necessity of acquisition with respect to each of the update data sets, and to transmit, to the different transmitting apparatus, one or more of the update data sets, for which the necessity of acquisition is affirmatively determined by the different transmitting apparatus.

10. A transmitting method used on first and second transmitting apparatuses making up a transmission system for transmitting data through a network, the transmitting method comprising:
acquiring, by the first transmitting apparatus connected to the network and another network, distribution data from the second network, the distribution data including a plurality of update data sets for updating the first transmitting apparatus and the second transmitting apparatus and update data attribute information of the update data sets; and
determining, by the second transmitting apparatus connected to the network, necessity of acquisition with respect to each of the update data sets stored in the first transmitting apparatus on the basis of the update data attribute information acquired from the first transmitting apparatus and information which enables identifying necessity of each of the update data sets in the second transmitting apparatus, and acquiring, from the first transmitting apparatus, one or more of the update data sets, for which the necessity of acquisition is affirmatively determined.
